(19) United States
(12) Patent Application Publication
(10) Pub. No.: US 2016/0161078 A1
(43) Pub. Date: Jun. 9, 2016

(54) LAMP FOR VEHICLE

(71) Applicant: Hyundai Motor Company, Seoul (KR)

(72) Inventors: Jin Ho NA, Suwon-si (KR); Byoung Suk AHN, Suwon-si (KR)

(21) Appl. No.: 14/712,557

(22) Filed: May 14, 2015

(30) Foreign Application Priority Data
Dec. 5, 2014 (KR) 10-2014-0174349

(51) Int. Cl. F21S 8/10; F21K 99/00

(52) U.S. Cl. CPC F21S 48/1757; F21S 48/1186; F21S 48/145; F21K 9/56; F21Y 2101/025

(57) ABSTRACT

A lamp for a vehicle includes a light source configured to generate light, a light guider configured to guide the light generated by the light source along a set moving path, and a barrier rib structure including a plurality of cells accommodating the light guided by the light guider. The barrier rib structure may be configured to emit the light accommodated in each cell in a shape of the cell.

CROSS-REFERENCE(S) TO RELATED APPLICATIONS

The present application claims priority to Korean Patent Application No. 10-2014-0174349, filed Dec. 5, 2014, the entire contents of which is incorporated herein for all purposes by this reference.

### TECHNICAL FIELD

Exemplary embodiments of the present invention relate to a lamp for a vehicle, and more particularly, to a lamp for a vehicle configured to implement a low beam or a high beam.

### BACKGROUND

A vehicle is mounted with various kinds of lamps depending on the purpose and attached position.

Among those, a headlight which is mounted at a front portion of a vehicle to irradiate light toward the front needs to selectively perform short-range irradiation and long-range irradiation depending on driver's intention or vehicle's own judgment. To implement this, the related art includes both a low-beam module and a high-beam module and may turn on or off each beam module to implement a selective lamp.

However, the existing lamp structure needs to include a plurality of beam modules, which is a factor in making a manufacturing process complicated and increasing costs and weight of a vehicle.

The matters described as the related art have been provided only for assisting in the understanding for the background of the present invention and should not be considered as corresponding to the related art known to those skilled in the art.

### SUMMARY

An embodiment of the present invention is directed to a lamp for a vehicle capable of implementing a clear beam while implementing both of a low beam and a high beam using a single lamp module.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a lamp for a vehicle includes: a light source configured to generate light; a light guider configured to guide the light generated by the light source along a set moving path; and a barrier rib structure including a plurality of cells accommodating the light guided by the light guider and configured to emit the light accommodated in each cell in the shape of the cell.

In certain embodiments, the light may be a laser beam.

In certain embodiments, the light guider may be a micro minor.

In certain embodiments, the light guider may irradiate light to each cell of the barrier rib structure.

In certain embodiments, each cell of the plurality of cells may be provided with a barrier rib which blocks the light incident on the cell from being transferred to adjacent cells.

Each cell of the barrier rib structure may be provided with a phosphor which generates light having a different wavelength from that of the laser beam

The barrier rib structure may be formed so that a barrier rib has a lattice shape.

The light guider may move from any one of the left and the right of the barrier rib structure to the other thereof and moves from any one of the upper and lower portions of the barrier rib to the other thereof and reflect the light from the light source to each cell.

In certain embodiments, the light guider may include a refractor configured to refract the light from the light source and an actuator configured to actuate the refractor so as to enable the refractor to move the light from the light source along the moving path.

In certain embodiments, the light guider may include a reflector.

In certain embodiments, each cell of the plurality of cells may have at least a minimum size at which the laser beam may be incident.

In certain embodiments, the light generated by the light source may be repeatedly turned on and off depending on a desired shape of the light guided by the light guider.

In certain embodiments, the lamp may further include a light collecting lens provided in front of the bather rib structure.

In certain embodiments, a reflector may be installed in an inner wall of the bather rib.

In certain embodiments, a lens may be installed in at least one cell of the plurality of cells.

### BRIEF DESCRIPTION OF THE DRAWINGS

FIG. 1 is a configuration diagram of a lamp for a vehicle in accordance with an exemplary embodiment of the present invention.

FIG. 2 is a cross-sectional view taken along the line A-A of FIG. 1.

### DETAILED DESCRIPTION

Hereinafter, a lamp for a vehicle in accordance with exemplary embodiments of the present invention will be described with reference to the accompanying drawings.

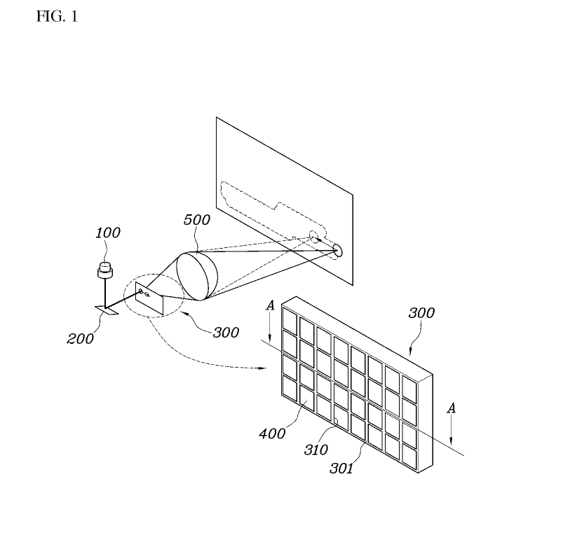

FIG. 1 is a configuration of a lamp for a vehicle in accordance with an exemplary embodiment of the present invention. In certain embodiments, the lamp for a vehicle includes a light source 100 configured to generate light, a light guider 200 configured to guide light from the light source 100 along a set moving path; and a barrier rib structure 300 configured to include a plurality of cells 310 accommodating light guided the light guider 200 and emit the light accommodated in each cell 310 in a shape of the cell 310. In certain embodiments, the light guider 200 may reflect the light generated by the light source. In certain embodiments, the light guider 200 may be configured to refract the light generated by the light source.

In certain embodiments, the light source 100 may be a laser diode which generates a laser beam but is not necessarily limited thereto, and therefore an LED or a light source of a general bulb type may be used.

However, the laser or a light source which generates a high-density straight beam similar to the laser is used, and thus the light guider 200 may accurately reflect the light from the light source 100 to a set point for reflection, thereby forming a high beam pattern or a low beam pattern.

Meanwhile, in certain embodiments, the light guider 200 may be a micro minor.

The micro minor is an apparatus which drives a minor mounted to be driven by electrostatic attraction so as to reflect light to a desired position by electrostatic attraction which is generated by a potential difference of applied voltage and may be implemented to set a point to which the light guider 200 reflects light in a moving path of light. A controller (not illustrated) may control the light guider 200 so as to enable the light guider 200 to move the light along the set path.

The micro minor is finely and rapidly operated so that the human eye may not sense a change in the micro minor. Therefore, even though the micro minor reflects light to a predetermined point (or a point set at the time of reflection) and then moves to reflect light to a next point, the change speed is very fine and rapid, and therefore the moving path of light which is continuously generated may irradiate light as if a general bulb or an LED continuously irradiates light due to an afterimage.

Therefore, the micro mirror may implement the beam pattern in a desired shape and implement the low beam or the high beam and when there is an oncoming vehicle, and the micro minor may be controlled to set the moving path in the corresponding cell 310 so as not to irradiate light to the oncoming vehicle. In certain embodiments, the light source 100 may be turned off when the image or the shadow of the vehicle passes through the corresponding cell 310.

As another exemplary embodiment of the light guider 200, instead of the mirror, a refractor, for example, a lens, an optic lens, and the like, which refracts the light from the light source 100, or other reflectors may also be used. Further, the light guider 200 may be provided with an actuator (not illustrated), for example, a step motor which actuates the refractor or the reflector to enable the refractor or the reflector to move the light from the light source 100 along the moving path and the controller may control the actuator similar to the foregoing micro minor.

In certain embodiments, the the barrier rib structure 300 has a shape in which each cell is set and may be provided with a barrier rib 301 which blocks the light incident on each cell from being transferred to adjacent cells. The barrier rib 301 is formed to have various shapes and each cell 310 may contact the adjacent cells 310, having the barrier rib 301 therebetween. A connection shape between the cells 310 may be variously formed and a shape of the barrier rib structure 300 is not also limited to any one.

In certain embodiments, the barrier rib 301 of the barrier rib structure 300 may be formed to have a lattice shape, which may increase space utilization capability by removing an extra space between the adjacent cells 310 and increase the resolution of the beam pattern which is finally formed by the operation of the light guider 200.

The number of cells 310 may be variously set in the barrier rib structure 300. In certain embodiments, each cell 310 has a minimum size at which a laser beam may be incident and thus the number of cells 310 may be configured as many as possible.

In certain embodiments, the light guider 200 moves light along the set moving path as described above and may reflect the light from the light source 100 to irradiate light to each cell 310 of the barrier rib structure 300.

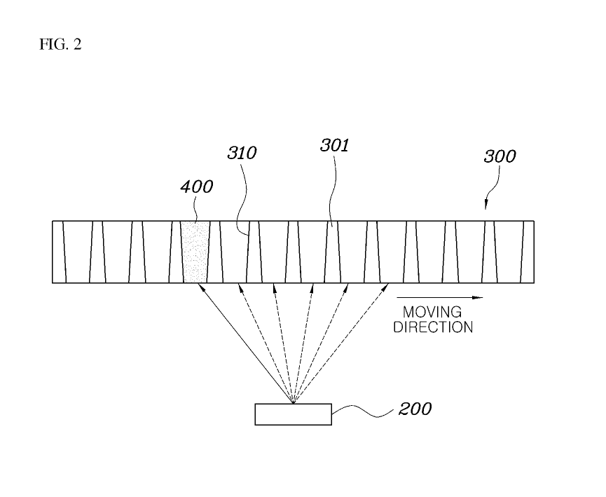

In detail, FIG. 2 is a cross-sectional view taken along the line A-A of FIG. 1, in which the light guider 200 irradiates the light from the light source 100 toward each cell 310. In certain embodiments, the light guider 200 moves from any one of the left and the right of the barrier rib structure to the other thereof and moves from any one of the upper and lower portions of the barrier rib to the other thereof and may reflect the light from the light source 100 to each cell. For example, in the embodiments where the barrier rib structure 300 in which the cells 310 are arranged in the shape of a lattice and the light guider 200 is a reflector, the light guider 200 may move while reflecting the light from the light source 100 to each cell 310 in a direction from the left of the barrier rib structure 300 toward the right thereof, moves one block down and then moves while reflecting the light from the light source 100 to each cell 310 in a direction from the right toward the left, such that the light guider 200 may continuously proceed. Further, this is only one exemplary embodiment and the path through which the light guider 200 moves while reflecting the light from the light source 100 to each cell 310 may be variously set depending on the designer's intention.

Further, in certain embodiments, the light from the light source 100 may be repeatedly turned on and off depending on the shape to be finally implemented while the light guider 200 moves. For example, in the case of implementing the low beam pattern, to implement the low beam pattern while the light guider 200 moves along the set path, the light source 100 is turned on at a portion at which light emission is required and the light source 100 is turned off at a portion at which light emission is not required, such that as illustrated in FIG. 1, the finally irradiated shape may be implemented to draw the low beam pattern. Further, this is the same for the case of the high beam pattern, too and various beam patterns may be implemented by the above configuration.

An exemplary embodiment of the present invention describes that the light guider 200 moves along a constant straight path and the beam pattern is implemented by the turn on/off of the light source 100, but each cell 310 of the barrier rib structure 300 may also move to make the set path draw the desired beam pattern shape. That is, in certain embodiments, the beam pattern may not be implemented by the turn on/off function of the light source 100 but rather the light guider 200 may be operated to draw the beam pattern.

As such, various exemplary embodiments may be applied to a method for implementing a final beam pattern by driving the light guider 200.

In certain embodiments, each cell 310 of the barrier rib structure 300 may be provided with a phosphor 400 which generates light having a different wavelength from that of the laser beam.

When the laser beam is directly irradiated to human eyes, the eyes may be seriously hurt. Therefore, the phosphor 400 may be used so that the laser beam may implement a function as a lamp. When the phosphor 400 receives the laser beam having a blue light wavelength, the phosphor 400 outputs light having a yellow light wavelength and some of the blue light wavelength is mixed with the yellow light wavelength and thus white light is finally irradiated forward.

Further, to collect the light transmitting the barrier rib structure 300 to a the set point, in certain embodiments, a separate light collecting lens 500 may be provided in front of the barrier rib structure 300.

The phosphor 400 may be provided to fully fill each cell 310 but is not necessarily so and therefore the cell 310 may be partially filled depending on the designer's intention.

As such, in certain embodiments, when the phosphor 400 is provided within the barrier rib structure 300 and thus when the laser beam is incident on the phosphor 400, the light spreading phenomenon may be reduced, and since the bather rib 310 blocks light from being transferred to the adjacent cells 310, light is emitted only to the cell 310 on which the laser beam is incident, and thus the high-resolution beam pattern shape may be obtained.

As described above, an exemplary embodiment of the present invention describes the case in which the phosphor is provided in the cell 310. However, in certain embodiments, a light source 100 which does not require the phosphor may be used and various exemplary embodiments such as inserting the lens, not the phosphor, into the cell 310 and installing the reflector in the inner wall of the barrier rib 301 may be variously implemented.

According to the lamp for a vehicle having the foregoing structure, it is possible to save manufacturing costs, reduce the weight of the vehicle, and shortening the manufacturing process by including, in certain embodiments, a mirror which reflects the light to move the light along the set moving path to implement the low beam or the high beam along the moving path of light.

Further, in certain embodiments, it is possible to form a high-resolution beam pattern by preventing the light incident on the cell from being transferred to the adjacent cells due to the barrier rib structure so as to prevent the light spreading phenomenon.

Although specific exemplary embodiments of the present invention have been shown and described above, various modifications and alterations may be made without departing from the spirit and scope of the present invention as defined by the following claims.

What is claimed is:

1. A lamp for a vehicle, comprising:
a light source configured to generate light;
a light guider configured to guide the light generated by the light source along a set moving path; and
a barrier rib structure including a plurality of cells accommodating the light guided by the light guider and configured to emit the light accommodated in each cell of the plurality of cells in a shape of the cell.

2. The lamp of claim 1, wherein the light is a laser beam.

3. The lamp of claim 1, wherein the light guider is a micro mirror.

4. The lamp of claim 1, wherein the light guider irradiates light to each cell of the barrier rib structure.

5. The lamp of claim 1, wherein each cell is provided with a barrier rib which blocks the light incident on the cell from being transferred to adjacent cells.

6. The lamp of claim 2, wherein each cell of the barrier rib structure is provided with a phosphor which generates light having a different wavelength from that of the laser beam.

7. The lamp of claim 5, wherein the barrier rib structure is has a lattice shape.

8. The lamp of claim 1, wherein the light guider moves from the left or the right of the bather rib structure to the other thereof and moves from the upper or lower portion of the barrier rib to the other thereof and guides the light from the light source to each cell.

9. The lamp of claim 1, wherein the light guider includes a refractor configured to refract the light from the light source.

10. The lamp of claim 1, wherein the light guider includes a reflector.

11. The lamp of claim 1, further comprising an actuator configured to actuate the light guider so as to enable the light guider to guide the light generated by the light source along the moving path.

12. The lamp of claim 2, wherein each cell has at least a minimum size at which the laser beam may be incident.

13. The lamp of claim 1, wherein the light generated by the light source is repeatedly turned on and off depending on a desired shape of the light guided by the light guider.

14. The lamp of claim 1, further comprising:
a light collecting lens provided in front of the barrier rib structure.

15. The lamp of claim 5, wherein a reflector is installed in an inner wall of the bather rib.

16. The lamp of claim 1, wherein a lens is installed in at least one cell of the plurality of cells.
